(19) United States
(12) Patent Application Publication
(10) Pub. No.: US 2015/0099490 A1
(43) Pub. Date: Apr. 9, 2015

(54) Systems and Methods of Onscreen Notification

(71) Applicant: COX COMMUNICATIONS, INC., Atlanta, GA (US)

(72) Inventors: Robert Clark Whitten, Kennesaw, GA (US); Ronald Larry Hardzog, JR., Sapulpa, OK (US)

(73) Assignee: COX COMMUNICATIONS, INC., Atlanta, GA (US)

(21) Appl. No.: 14/049,173

(22) Filed: Oct. 8, 2013

(51) Int. Cl. H04M 1/725; H04W 4/12

(52) U.S. Cl. CPC H04M 1/72577; H04W 4/12; H04M 1/72552
USPC 455/412.2

(57) ABSTRACT

Methods and systems are provided of showing an onscreen message comprising including receiving a message from a sender at a service provider, determining that the sender is associated with a subscriber account wherein one or more networked subscriber devices are associated with the subscriber account, and routing the message to the one or more networked subscriber devices, the message identifying at least one designated action to be performed by the one or more networked subscriber devices.

### TECHNICAL FIELD

The present disclosure is generally related to messaging and, more particularly, is related to providing onscreen message notifications.

### BACKGROUND

Instant messaging and email are useful methods of communication; however, it can be difficult for a sender to confirm receipt of a message by the recipient. There are a variety of reasons for this including interception via a spam filter, or delivery of the message to the sender when the recipient's attention is directed elsewhere. At the same time, ever increasing amounts of time and attention are spent viewing device screens and other displays.

Whatever the cause, difficulty confirming receipt may compound other issues as well. For example, it can be difficult for a sender to confirm acknowledgement of an assigned task on the part of the recipient, such as requesting completion of a chore, guitar practice, or doing homework.

Due to portable devices and network connectivity, users can view and enjoy media when out and about via smartphone, computer, or tablet in addition to enjoying media in traditional home-based locations via a television attached to a set top box DVR.

Additionally, despite advancements in the area of parental controls combined with existing difficulties confirming receipt of a message by a recipient, it may be difficult to enforce, or impose new restrictions on access to media and gaming devices remotely. There are heretofore unaddressed needs with previous solutions.

### SUMMARY

Example embodiments of the present disclosure can be viewed as providing methods for onscreen notification. In this regard, one embodiment of such a method, among others, can be broadly summarized by the following steps: receiving a message from a sender at a service provider, determining that the sender is associated with a subscriber account wherein one or more networked subscriber devices are associated with the subscriber account, routing the message to the one or more networked subscriber devices, the message identifying at least one designated action to be performed by the one or more networked subscriber devices.

According to yet another embodiment of the present disclosure, a method for providing onscreen notification is provided including the steps of: receiving a request message from an authenticated user at a service provider wherein one or more connected devices are associated with the authenticated user, processing the request message to identify one or more commands for the one or more connected devices, based at least in part on the request message, generating one or more device instructions, sending the one or more device instructions to the one or more connected devices, the one or more device instructions identifying a device operation to be performed and a text note to be displayed by the one or more connected devices.

According to still yet another embodiment of the present disclosure, example embodiments of the present disclosure provide systems of onscreen notification that can be implemented as follows: at least one memory operable to store computer-executable instructions, at least one communications interface to access the at least one memory, and at least one processor configured to access the at least one memory via the at least one communications interface and execute the computer-executable instructions to: receive a request message from an authenticated user at a service provider wherein one or more connected devices are associated with the authenticated user, process the request message to identify one or more commands for the one or more connected devices, based at least in part on the request message, generate one or more device instructions, and send the one or more device instructions to the one or more connected devices, the one or more device instructions identifying a device operation to be performed and a text note to be displayed on the one or more connected devices.

### BRIEF DESCRIPTION OF THE DRAWINGS

FIG. 1 illustrates an exemplary environment in which an embodiment in accordance with the present disclosure may be practiced.

FIG. 2 illustrates an example system for supporting provision of an enhanced electronic program guide according to an example embodiment of the disclosure.

FIG. 3A shows an exemplary text message sent to a service provider in accordance with one or more embodiments of the present disclosure.

FIG. 3B shows an exemplary screen at a networked device showing the results of the text message in accordance with one or more embodiments of the present disclosure.

FIG. 3C shows an exemplary text message sent to a service provider in accordance with one or more embodiments of the present disclosure.

FIG. 3D shows an exemplary screen at a networked device showing the results of the text message in accordance with one or more embodiments of the present disclosure.

FIG. 4A shows an exemplary text message sent to a service provider in accordance with one or more embodiments of the present disclosure.

FIG. 4B shows an exemplary screen at a networked device showing the results of the text message in accordance with one or more embodiments of the present disclosure.

FIG. 4C shows an exemplary screen at a networked device showing the results of the text message in accordance with one or more embodiments of the present disclosure.

FIG. 5 schematically illustrates an application in accordance with an alternate example embodiment of the disclosure.

FIG. 6 is a block diagram illustration of a method for providing on screen messaging in accordance with an example embodiment of the disclosure.

FIG. 7 is a block diagram illustration of a method for providing on screen messaging in accordance with an alternate example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

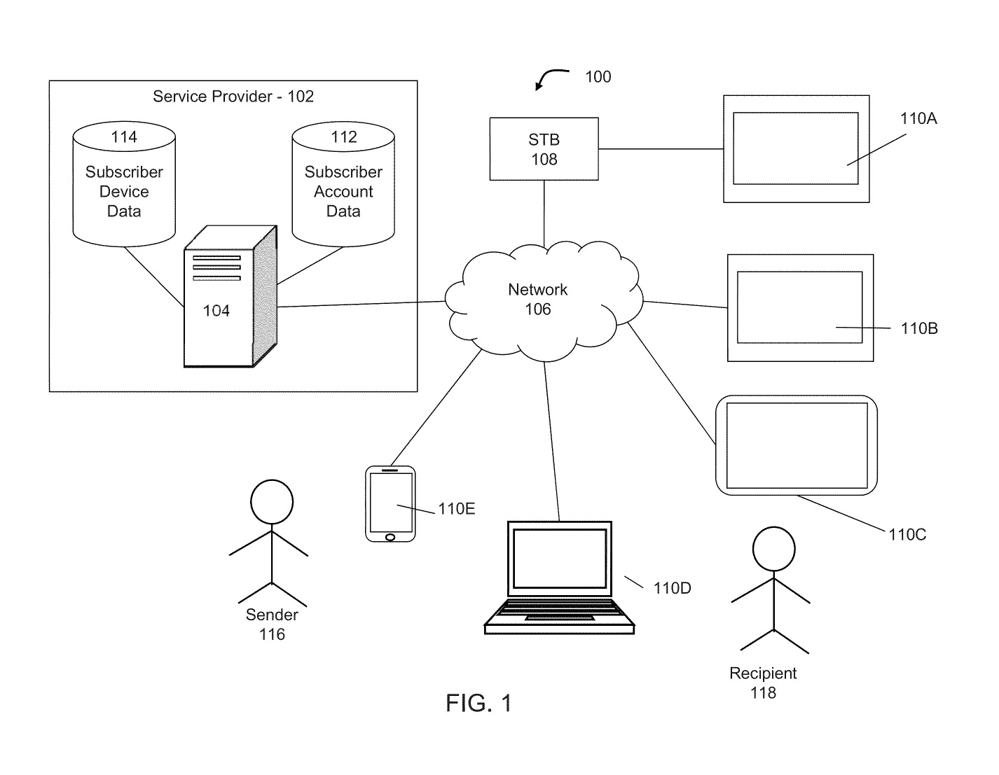

Referring now to the drawings in which like numerals represent like elements or steps throughout the several views, FIG. 1 is block diagram of exemplary environment 100 for providing onscreen messaging in accordance with the present disclosure. Exemplary environment 100 may comprise service provider 102, such as an Internet Service Provider, or Cable Television Provider, that includes service provider server 104 attached via network 106 to multiple data repositories including subscriber account data 112 and subscriber device data 114.

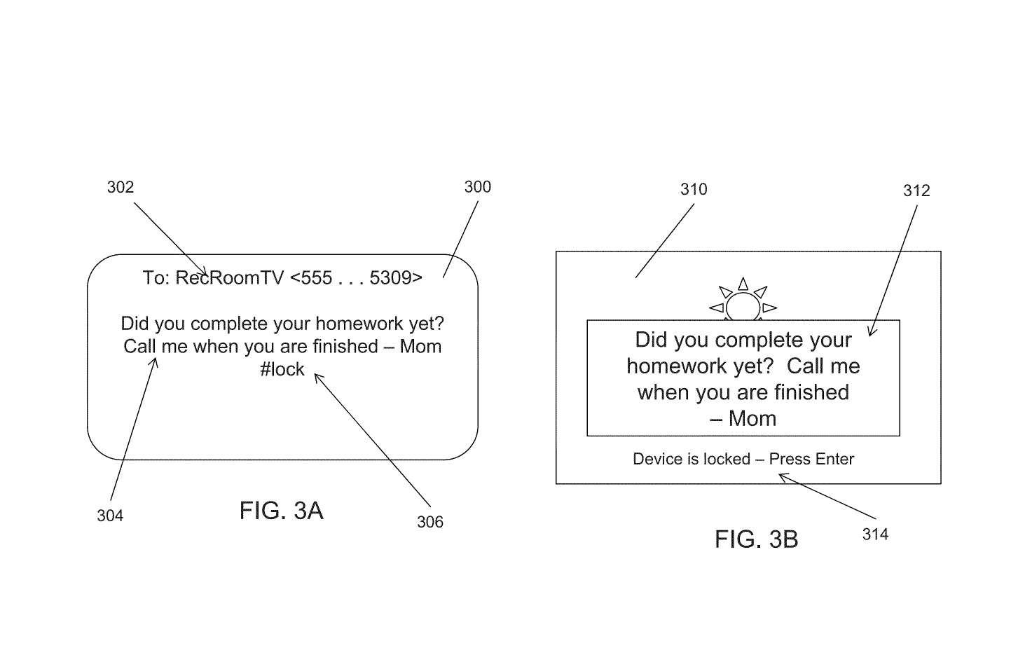

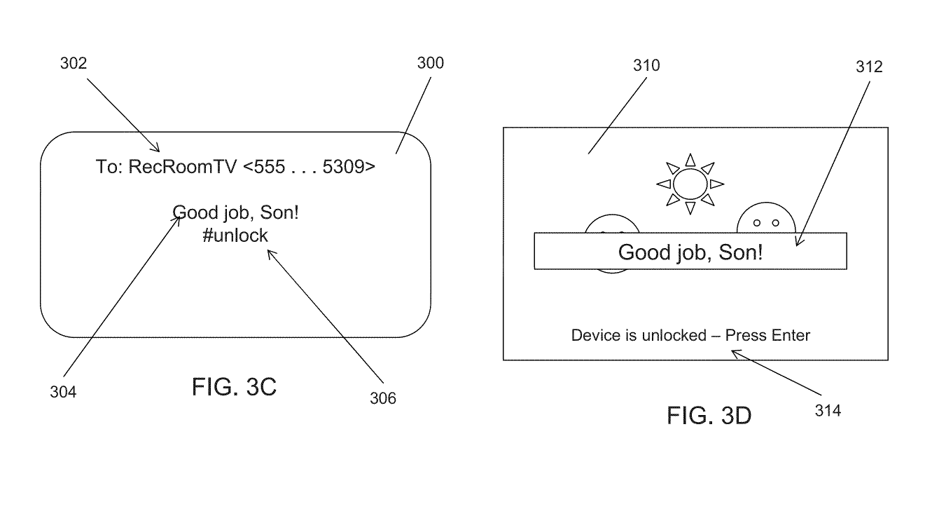

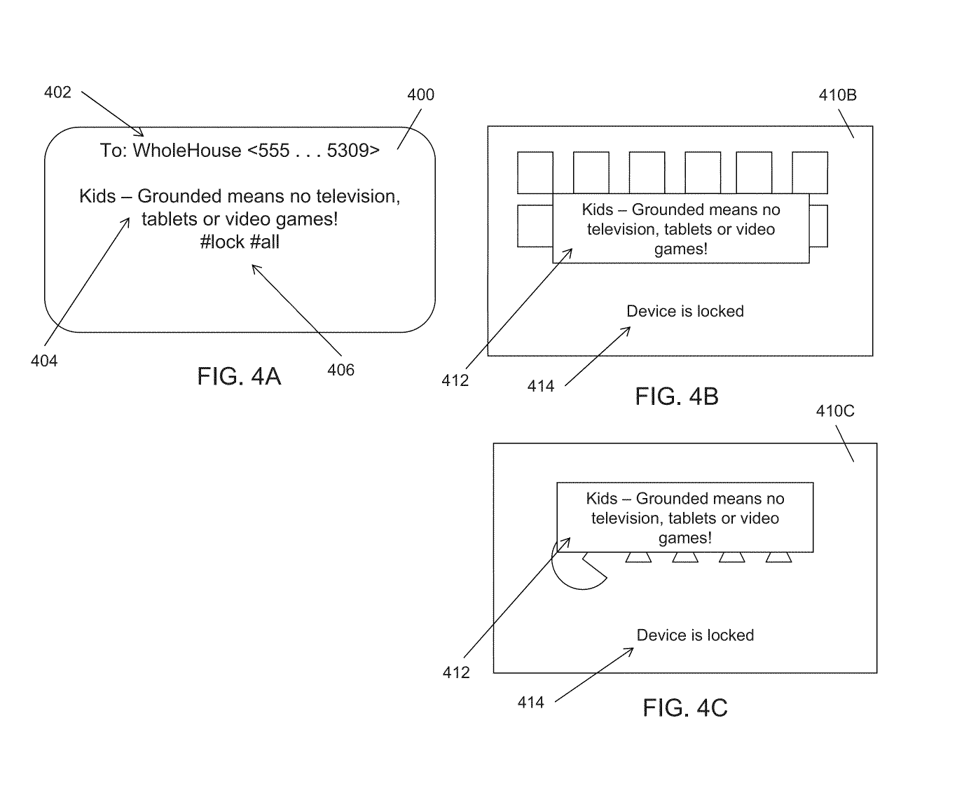

Content from service provider 102 may be transmitted for distribution over network 106 to Set Top Box (STB) 108 and one or more networked devices 110A-E. Content may either be sent directly to networked devices 110A-E or sent to STB 108 (also a networked device) for use on networked devices 110A-E. Examples of content include audio, video, and/or other data and/or signals, instructions, directions, and messages as depicted in FIGS. 3B, 3D, 4B, and 4C.

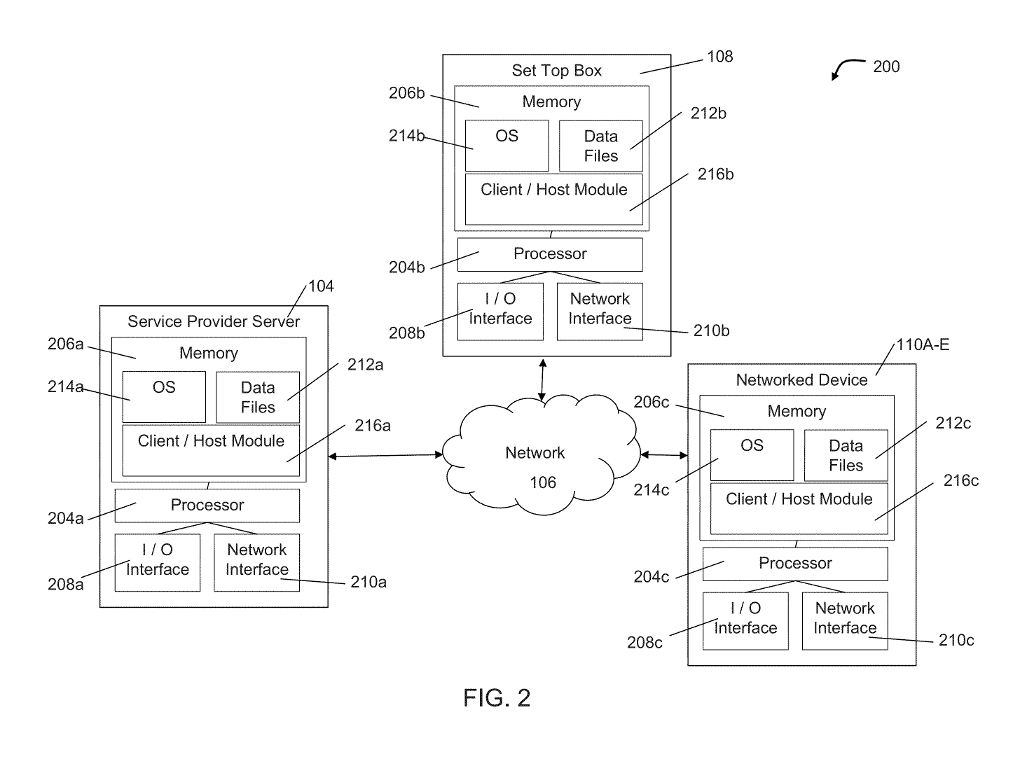

Service provider server 104 may comprise a computing device as described below with respect to FIG. 2. Consistent with embodiments of the disclosure, service provider server 104 may comprise one or more software applications (i.e., a series of instructions configured for execution by a processing unit) associated with another component, such as one or more servers or dedicated content devices.

Network 106 (also referred herein as distribution network or communication network) is, generally, used and implemented by a cable service provider (such as, but not limited to, a wired and/or wireless communication service provider) to enable the service provider to provide, and the service provider's subscribers to receive content and communication services. Network 106 additionally refers to infrastructure, including apparatuses and methods, operative and utilized to communicate data and/or signals between networked devices such as service provider server 104, STB 108, and networked devices 110A-E. Similarly, for example and not limitation, network 106 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 106 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. Network 106 may also allow for real-time, off-line, and/or batch transactions to be transmitted between or among service provider server 104, STB 108, and networked devices 110A-E. Due to network connectivity, various methodologies as described herein may be practiced in the context of distributed computing environments.

Although STB 108 is shown for simplicity in an example embodiment as being in communication with service provider server 104 via one intervening network 106, it is to be understood that other network configurations may be used. For example, intervening network 106 may include a plurality of networks, each with devices such as gateways and routers for providing connectivity between or among networks. Instead of, or in addition to network 106, dedicated communication links may be used to connect the various devices in accordance with example embodiments of the disclosure. For example, STB 108 may form the basis of network 106 that interconnects one or more networked devices 110A-E.

As shown in FIG. 1, components of example environment 100 including service provider 102, service provider server 104, STB 108, and networked devices 110A-E may be in communication with each other via a network such as network 106, which as described herein can include one or more separate or shared private and public networks, including the Internet or a publicly switched telephone network. STB 108 may include a stand alone or integrated devices such as a pc, media server, television tuner, satellite or cable receiver, digital video recorder, video game console, Blu-ray player, tablet, smart device, embedded devices, and the like. Networked devices 110A-E may include one or more of video playback screen, tablet device, smart phone, PDA, or other devices with one or more connectivity options. Networked devices 110A-E may further include an LCD display device such as a monitor featuring an operating system, media browser, and the ability to run one or more software applications. Networked devices 110A-E may also include the same features, capabilities, hardware, and functionality of STB 108.

Service provider server 104 is shown in communication with multiple data repositories including subscriber account data 112 and subscriber device data 114. It will be appreciated that the terms subscriber and user are used interchangeably herein. It will further be appreciated that the terms networked and connected are used interchangeably herein. While illustrated as separate data repositories, it is to be understood that information included in repositories 112 and 114 may be stored in a single repository, or multiple repositories across different locations.

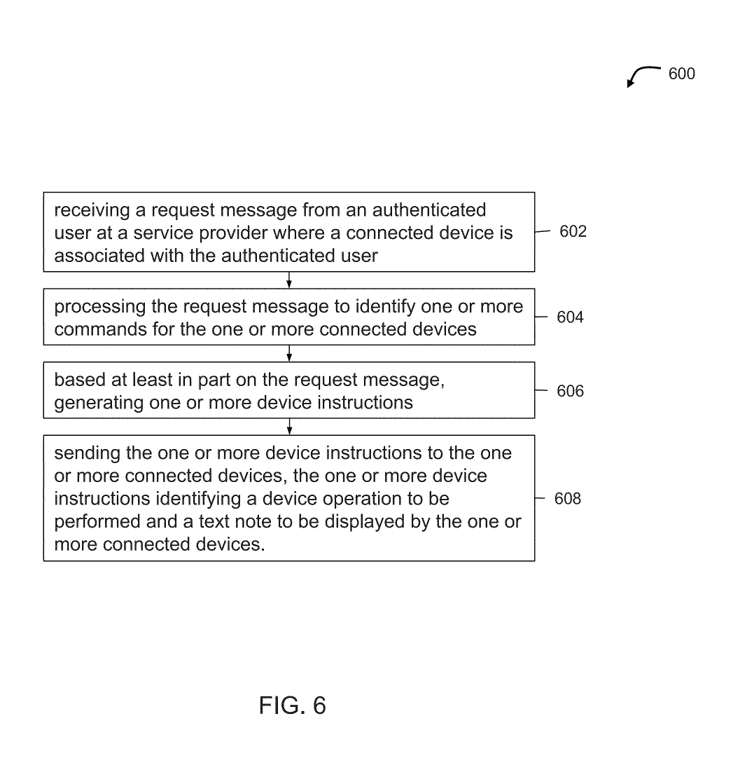

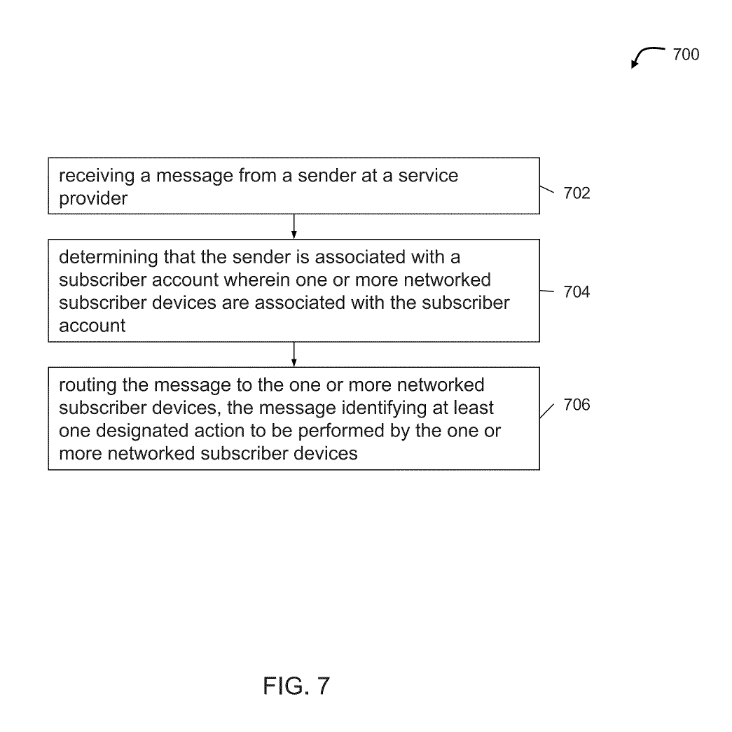

In an example embodiment, service provider server 104 receives a message from sender 116 and looks up information about sender 116 using subscriber account data 112. Once service provider server 104 has associated sender 116 with information from subscriber account data 112, service provider server then locates information corresponding to the subscriber account information in subscriber device data 114. By way of example, as detailed in by FIGS. 6 and 7, service provider server 104 receives message from sender 116. Service provider server 104 determines that the sender's address is associated with subscriber information using subscriber account data 112, such as a subscriber record. Service provider server 104 then determines that subscriber information is associated with information from subscriber account data 114 such as one or more subscriber devices such as set top box 108 and one or more networked devices 110A-E such as a smart tablet and smart phone.

Sender 116 may or may not be a subscriber or user of services provided by service provider 102. According to an embodiment of the present disclosure, sender 116 (such as a babysitter or nanny) may be designated as being authorized to send messages to a recipient on behalf of a subscriber.

FIG. 2 illustrates an example system 200 for supporting provision of onscreen messaging according to an example embodiment of the disclosure. Service provider server 104, STB 108, and networked devices 110A-E may be any processor-driven device, such as, but not limited to, a personal computer, laptop computer, handheld computer, dedicated processing device, and/or an array of computing devices. In addition to having processor 204a-c, server 104, STB 108, and networked devices 110A-E may further include memory 206a-c, input/output (“I/O”) interface(s) 208a-c, and network interface 210a-c. Memory 206a-c may be any computer-readable medium, coupled to the processor, such as RAM, ROM, and/or a removable storage device for storing data files 212a-c and a database management system (“DBMS”) to facilitate management of data files 212a-c and other data stored in memory 206a-c and/or stored in separate databases. Memory 206a-c may store data files 212a-c and various program modules, such as operating system (“OS”) 214a-c and client module 216a-c. OS 214a-c may be, but is not limited to, Microsoft Windows®, Apple OSX™, Unix, Linux, Android, or a mainframe operating system. Client module 216a-c may be an Internet browser or other software, including a dedicated program, for interacting with server 104, network 106, STB 108, and/or networked devices 110A-E.

Suitable processors, such as processors 204a-c of service provider server 104, STB 108, and networked devices 110A-E, respectively, may comprise a microprocessor, an ASIC, and/or a state machine. Example processors may include those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein.

Generally, each of the memories and data storage devices, such as memories 206a-c and databases 112 and 114 (as shown in FIG. 1), and/or any other memory and data storage device, can store data and information for subsequent retrieval. In this manner, systems can store various received or collected information in memory or a database associated with service provider server 104, STB 108, and/or networked devices 110A-E. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission devices capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Generally, service provider server 104, STB 108, and networked devices 110A-E have hardware and/or software for transmitting and receiving data and/or computer-executable instructions over a communications link and a memory for storing data and/or computer-executable instructions. These devices and systems may also include a processor for processing data and executing computer-executable instructions locally and over network 106, as well as other internal and peripheral components that are well known in the art.

Still referring to service provider server 104, STB 108, and networked devices 110A-E, the I/O interface(s) 208a-c may facilitate communication between the processor 204a-c and various I/O devices, such as a keyboard, mouse, printer, microphone, speaker, monitor, bar code readers/scanners, RFID readers, and the like. Network interface 210a-c may take any of a number of forms, such as a network interface card, a modem, a wireless network card, and the like. It will be appreciated that while service provider server 104, STB 108, and networked devices 110A-E have been illustrated as a single computer or processor, the service provider server 104, STB 108, and networked devices 110A-E may be comprised of a group of computers or processors, according to an example embodiment of the disclosure.

As previously mentioned, network 106 may takes many forms, including a public and/or a private network, such as a cable television distribution network (e.g., a hybrid fiber-coax network), a cellular data network, a metropolitan WiMAX network, and/or the Internet.

Exemplary environment 100 shown in and described with respect to FIGS. 1 and 2 are provided by way of example only. Numerous other operating environments, system architectures, and device configurations are possible. Other system embodiments can include fewer or greater numbers of components and may incorporate some or all of the functionality described with respect to the system components shown in FIGS. 1 and 2.

For example, in one embodiment, service provider server 104 (or STB 108/networked devices 110A-E) may be implemented as a specialized processing machine that includes hardware and/or software for performing the methods described herein. In addition, the processor and/or processing capabilities of service provider server 104, may be implemented as part of STB 108, networked devices 110A-E, or any portion or combination thereof. Accordingly, embodiments of the disclosure should not be construed as being limited to any particular operating environment, system architecture, or device configuration.

Turning to FIGS. 3A-D, FIGS. 3A and 3C are an illustration of sender message composition screen 300 such as may be found on a mobile telephone, instant message program, or email program. As shown, address 302 shows that the message is directed to the RecRoomTV. It will be appreciated that according to some embodiments of the present disclosure, other devices may be addressable via the address a message is sent to or via use of one or more keywords. Note text 304 is intended to be displayed on screen 310 of associated networked devices (110A-E) as shown in FIGS. 3B and 3D. Note text 304 is displayed on screen 310 that is associated with networked devices 110A-E as item 312. System message 314 indicates what command has been performed by networked device 110A-E in response to the message from sender 116 (from FIG. 1).

Using message composition screen 300, sender 116 may include one or more keywords that will cause networked device 110A-E to carry out one or more device operations. As shown in FIG. 3A, sender 116 has indicated that networked device 110A-E is to lock by inclusion of keyword 306 “#lock” following note text 304 portion of the message. System message 314 provides a visual indication to recipient 118 (from FIG. 1)/user of networked device 110, that the device has been locked. Message text 312 additionally informs recipient 118/user of networked device 110A-E, that he or she should call Mom when homework has been completed.

It is to be understood that locked may refer to restricting the functionality of networked device 110A-E and that restricting functionality may limit media viewing/playback or could involve prohibiting any use of the networked device 110A-E beyond displaying message text 312. It will be appreciated that device operations may involve activation of device features such as remotely activating parental controls and/or restricting viewing options such as only permitting content deemed to be educational.

Turning to FIG. 3C, sender 116, using message composition screen 300, has included keyword 306 “#unlock” using the pound/hash symbol to cause networked device 110A-E to carry out the device operation of unlocking. As shown in FIG. 3D, system message 314 provides a visual indication to recipient 118/user of networked device 110A-E, that the device has been unlocked. Message text 312 informs recipient 118/user of networked device 110A-E, that he has done a good job.

It will be appreciated that various forms of messaging are contemplated by the present disclosure including text, MMS, SMS, iMessage, email, Skype, and instant messaging such as ICQ, Jabber, Google talk, AOL, Yahoo, IRC, and the like. It is to be understood that the described message syntax is provided by way of example and is in no way limiting. By way of example, according to some embodiments, a sender could employ the use of emoticons or emoji icons in messages to designate certain commands, and/or instructions. It will be appreciated by one of ordinary skill in the art that the present disclosure is compatible with the use of various protocols, encoding, encryption, and authentication methods.

It will also be appreciated that according to some embodiments of the present disclosure, that networked devices may be categorized and/or placed into groups. For example, the sender may opt to select an entire group of devices to receive a message. Alternatively, the sender may select one or more individual devices from the group to receive the message. According to yet another embodiment, the sender may select those networked devices that fall into the tablet category to receive a message.

FIG. 4A illustrates sender 116 (shown in FIG. 1) using message composition screen 400 such as may be found on a mobile telephone, instant message program, or email program. As shown, address 402 indicates that the message is directed to WholeHouse. Unlike address 302 from FIG. 3A (RecRoomTV), which was directed to a single device, the message depicted in FIG. 4A is addressed to all networked devices 110A-E in the house. Note text 404 is intended to be displayed on screen 410 on networked devices (110A-E) as shown in FIGS. 4B and 4C. As shown, note text 404 “Kids—Grounded means no television, tablets or video games!” is displayed on as item 412 on screens 410B (smartphone/tablet) and 410C (game console) of networked devices 110A-E. System message 414 informs recipient 118/user of networked devices 110A-E that the device is now locked.

Sender 116 has indicated that networked devices 110A-E are to be locked by inclusion of keyword 406 “Mock” following note text 404 portion of the message. According to some embodiments of the present disclosure, inclusion of keyword 406 “#all” following “#lock” may be used to instruct that all functionality of one or more designated networked devices 110A-E be restricted. According to other embodiments, such as may be the case if a single recipient address is used to address all networked devices 110A-E, use of keyword 406 “#all” following “#lock” may be used to instruct that all of networked devices 110A-E are to be locked as opposed to a particular device or set of devices.

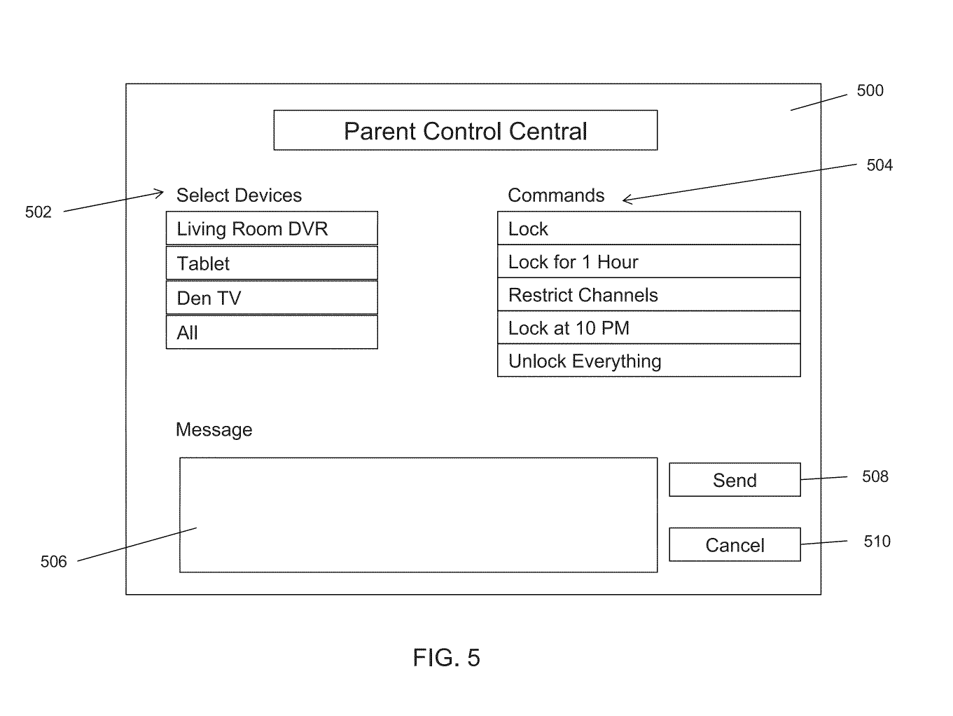

FIG. 5 schematically illustrates application program screen 500 as may be presented to an authenticated sender in accordance with an example embodiment of the disclosure. Application program screen 500 may be accessible via a password protected website and/or implemented as a web app or device specific application. As shown, list of subscriber devices 502 is provided along with list of instructions 504. Additionally, message note window 506 is provided as are command buttons send 508 and cancel 510. Various methods of sender authentication may be used including use of third party authentication services such as OpenID, Google, Facebook, LinkedIn, Microsoft, Yahoo, Paypal, in addition to use of service provider accounts, pin codes, and passcodes. While message note window 506 shows a place to enter text, it will be appreciated that the interface may provide a list of standard messages and previously sent messages for user selection.

FIG. 6 is a flow diagram illustration of instructions 600 for providing onscreen messaging in accordance with an example embodiment of the disclosure. In block 602, a request message from an authenticated user is received at a service provider wherein one or more connected devices are associated with the authenticated user. As described with respect to FIG. 5, sender 116 may be authenticated using one or more ways. Sender 116 may create the request message using a messaging program or an application program screen 500. At block 604, he request message is processed to identify one or more commands for the one or more connected devices. At block 606, based at least in part on the request message, one or more device instructions is generated. At block 608, the one or more device instructions is sent to the one or more connected devices, the one or more device instructions identifying a device operation to be performed and a text note to be displayed by the one or more connected devices.

FIG. 7 is a flow diagram illustration of instructions 700 for providing onscreen messaging in accordance with an alternate example embodiment of the disclosure. Per block 702, a message from a sender is received at a service provider. In block 704, the sender is associated with a subscriber account wherein one or more networked subscriber devices are associated with the subscriber account. In block 706, the message is routed to the one or more networked subscriber devices, the message identifying at least one designated action to be performed by the one or more networked subscriber devices.

It will be appreciated by one of ordinary skill in the art that the steps/instructions set forth in FIGS. 6 and 7 may be performed on service provider server 104, STB 108, or networked devices 110A-E.

The flow charts of FIGS. 6 and 7 show the architecture, functionality, and operation of a possible implementation of providing onscreen messaging. In this regard, each block represents a module, segment, or portion of code, which comprises one or more executable instructions for implementing the specified logical function(s). It should also be noted that in some alternative implementations, the functions noted in the blocks may occur out of the order noted in FIGS. 6 and 7. For example, two blocks shown in succession in FIGS. 6 and 7 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method of showing an onscreen message comprising the steps of:
receiving a message from a sender at a service provider;
determining that the sender is associated with a subscriber account wherein one or more networked subscriber devices are associated with the subscriber account; and
routing the message to the one or more networked subscriber devices, the message identifying at least one designated action to be performed by the one or more networked subscriber devices.

2. The method of claim 1 wherein the designated action to be performed on the one or more networked subscriber devices includes displaying a text message on a display screen associated with the one or more networked subscriber devices.

3. The method of claim 2 wherein the designated action to be performed on the one or more networked subscriber devices blocks a display associated with the one or more networked subscriber devices with a text message until the text message is acknowledged.

4. The method of claim 1 wherein the designated action to be performed on the one or more networked subscriber devices includes displaying a text message on a display screen and restricting one or more viewing features.

5. The method of claim 1 wherein the designated action to be performed on the one or more networked subscriber devices restricts full use of the one or networked subscriber more devices until a passcode is entered.

6. The method of claim 1 wherein the designated action to be performed on the one or more networked subscriber devices permits full use of the one or more networked subscriber devices.

7. The method of claim 1 wherein the designated action to be performed on the one or more networked subscriber devices limits viewing to selected media.

8. The method of claim 1 wherein the step of routing the message to the one or more networked subscriber devices further includes the step of appending a service provider identifier onto the message and the at least one designated action to be performed on the one or more networked subscriber devices further includes the step of verifying the authenticity of the service provider identifier in the message.

9. A method of showing an onscreen message comprising the steps of:
receiving a request message from an authenticated user at a service provider wherein one or more connected devices are associated with the authenticated user;
processing the request message to identify one or more commands for the one or more connected devices;
based at least in part on the request message, generating one or more device instructions; and
sending the one or more device instructions to the one or more connected devices, the one or more device instructions identifying a device operation to be performed and a text note to be displayed by the one or more connected devices.

10. The method of claim 9 wherein the authenticated user is authenticated via a web portal or a device application.

11. The method of claim 9 wherein the device operation to be performed on the one or more connected devices blocks the display with the text message until the message is acknowledged.

12. The method of claim 9 wherein the device operation to be performed on the one or more connected devices includes restricting one or more viewing features for one or more of the connected devices.

13. The method of claim 9 wherein the device operation to be performed on the one or more connected devices restricts full use of the one or more devices until a passcode is entered.

14. The method of claim 9 wherein the device operation to be performed on the one or more connected devices permits full use of the one or more devices.

15. The method of claim 9 wherein the device operation to be performed on the one or more connected devices limits viewing to selected media.

16. The method of claim 9 wherein the step of generating one or more device instructions further includes the step of appending a service provider identifier onto the message and the device operation to be performed on the one or more connected devices further includes the step of verifying the authenticity of the service provider identifier in the message.

17. A system for onscreen messaging, comprising:
at least one memory operable to store computer-executable instructions;
at least one communications interface to access the at least one memory; and
at least one processor configured to access the at least one memory via the at least one communications interface and execute the computer-executable instructions to:
receive a request message from an authenticated user at a service provider wherein one or more connected devices are associated with the authenticated user;
process the request message to identify one or more commands for the one or more connected devices;
based at least in part on the request message, generate one or more device instructions; and
send the one or more device instructions to the one or more connected devices, the one or more device instructions identifying a device operation to be performed and a text note to be displayed on the one or more connected devices.

18. The system of claim 17 wherein the device operation to be performed on the one or more connected devices restricts full use of the one or more devices until a passcode is entered.

19. The system of claim 17 wherein the device operation to be performed on the one or more connected devices permits full use of the one or more devices.

20. The system of claim 17 wherein the device operation to be performed on the one or more connected devices limits viewing to selected media.
